(19) United States
(12) Patent Application Publication
(10) Pub. No.: US 2009/0077631 A1
(43) Pub. Date: Mar. 19, 2009

(54) ALLOWING A DEVICE ACCESS TO A NETWORK IN A TRUSTED NETWORK CONNECT ENVIRONMENT

(76) Inventors: Susann Marie Keohane, Austin, TX (US); Gerald Francis McBrearty, Austin, TX (US); Shawn Patrick Mullen, Buda, TX (US); Jessica Carol Murillo, Round Rock, TX (US); Johnny Meng-Han Shieh, Austin, TX (US)

Correspondence Address: IBM CORP (YA);C/O YEE & ASSOCIATES PC, P.O. BOX 802333, DALLAS, TX, 75380, US

(21) Appl. No.: 11/854,762

(22) Filed: Sep. 13, 2007

(51) Int. Cl. H04L 9/32

(52) U.S. Cl. 726/3

(57) ABSTRACT

A computer implemented method of allowing a device access to a network in a trusted network connect environment. Responsive to receiving a request from the device to access the network, a type of the device is determined. Responsive to determining the type of the device, a policy for the device is determined based on the type of the device. Responsive to determining the policy for the device based on the type of the device, determining whether an integrity of the device satisfies the policy. Responsive to determining that the device does not satisfy the policy, performing a remediation action on the device. Responsive to determining that the device satisfies the policy, allowing the device access to the network.

### BACKGROUND OF THE INVENTION

1. Field of the Invention

The present invention relates generally to data processing systems and in particular to trusted network connect environments. Still more particularly, the present invention related to a computer implemented method, apparatus, and computer program code for allowing a device access to a network in trusted network connect environment.

2. Description of the Related Art

Guarding against the influx of malicious, unauthorized software in a network environment is a constant battle for businesses. Spyware, malware, and adware, not to mention viruses and other programs can invade a network using system resources to slow performance. Worse, malicious viruses can attack data on the network costing a business valuable information, much of which can not be recovered.

While businesses have gone to great lengths to install virus protection programs, many of these protection schemes do not protect the network from unauthorized programs that may be contained in a hardware device. CDs, memory sticks, and other storage mediums used by an employee may be infected with unauthorized programs from the employee's personal computer that can spread to the network when the employee introduces the device to the network.

### SUMMARY OF THE INVENTION

The illustrated embodiments described herein provide a computer implemented method, a computer program product, and a data processing system for allowing a device access to a network in a trusted network connect environment. Responsive to receiving a request from the device to access the network, a type of the device is determined. Responsive to determining the type of the device, a policy for the device is determined based on the type of the device. Responsive to determining the policy for the device based on the type of the device, determining whether the device satisfies the policy. Responsive to determining that the device does not satisfy the policy, performing a remediation action on the device. Responsive to determining that the device satisfies the policy, allowing the device access to the network.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network for data processing systems in accordance with an illustrative embodiment;

FIG. 2 is a block diagram of a data processing system in which illustrative embodiments may be implemented;

FIG. 3 is a block diagram of connecting a simple network device to a network with a trusted network connect architecture in accordance with an illustrative embodiment;

FIG. 4 is a flowchart for a software process providing authentication, authorization and accounting (AAA) services according to an illustrative embodiment of the invention in accordance with illustrative embodiments; and

FIG. 5 is a flowchart for a software processes providing external integrity verification of a device in accordance with illustrative embodiments.

### DETAILED DESCRIPTION OF THE PREFERRED EMBODIMENT

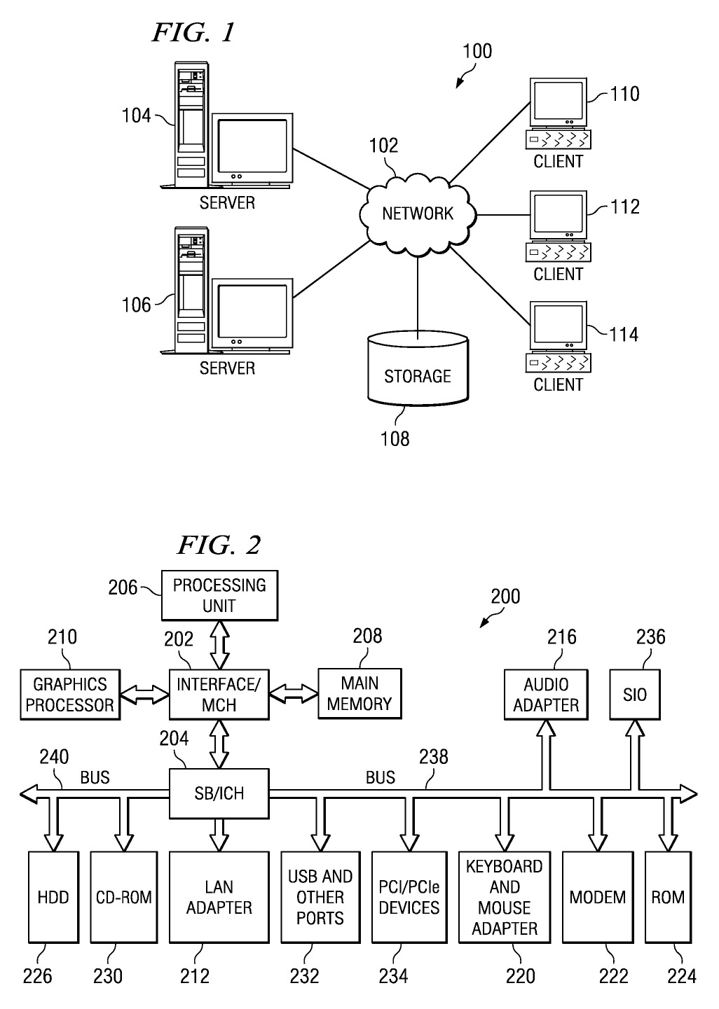

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including interface and memory controller hub (interface/MCH) 202 and interface and input/output (I/O) controller hub (interface/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to interface bridge and I/O controller hub 204 through bus 238, and hard disk drive (HDD) 226 and CD-ROM 230 are coupled to interface bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

When a company has many devices, such as computers and servers, the company also has an internal network which connects the devices. A large company, with locations around the world, may create a very large internal network. An internal network of a company may be comprised of both wired and wireless sub-networks. A major concern with an internal network is securing the internal network. For example, the owner of the internal network may wish to secure the internal network to prevent unauthorized users from accessing the internal network. Similarly, the owner of the internal network may wish to secure the internal network from malware.

Malware is malicious or unwanted software designed to infiltrate or damage devices connected to a network without the consent of the owner of the network. A trusted network connect (TNC) architecture is a network architecture for securing a network, such as an internal network of a company. For example, the trusted network connect (TNC) architecture may be designed to prevent malware from gaining access to the internal network of a company.

When an intelligent device, such as a laptop, is connected to a network with a trusted network connect (TNC) architecture, the intelligent device may be required to provide information before the intelligent device is allowed to connect to the network. For example, a laptop may be asked to provide information such as the last time a virus scan was performed, and the date when the virus definitions were last updated. Based on the information provided by the intelligent device, the trusted network connect (TNC) architecture determines whether to allow the laptop to connect to the network.

In contrast to an intelligent device, a simple network device, such as a disk drive, is usually not able to provide the information to a trusted network connect (TNC) architecture required to determine whether to allow the simple network device to connect to the network. For example, a disk drive typically lacks the intelligence to know if the disk drive contains malware, such as a virus. If the trusted network connect (TNC) architecture allows the disk drive to connect to the network, then the malware on the disk drive may infiltrate the network. Therefore, the illustrated embodiments recognize a need for determining whether to allow a device, such as a simple network device, to connect to a network.

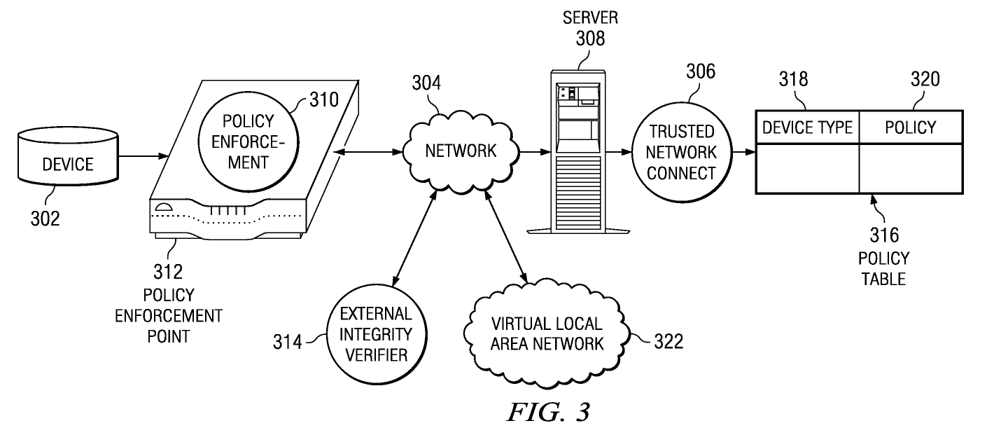

FIG. 3 is a block diagram of connecting a simple network device to a network with a trusted network connect architecture in accordance with illustrative embodiments. Device 302 is a simple network device connecting to a network with a trusted network connect architecture 300. For example, device 302 may be a network attached disk or a network attached robot using internet small computer system interface (iSCSI) protocol to connect to network 304. Internet small computer system interface (iSCSI) protocol is a network protocol standard which allows the use of the small computer system interface (SCSI) protocol over networks using transmission control protocol/internet protocol (TCP/IP). Network 304 may be a wired network, a wireless network, or a combination of a wired network and a wireless network. For example, network 304 may use a variety of protocols, including Ethernet, transmission control protocol/internet protocol (TCP/IP), and Institute of Electrical and Electronics Engineers (IEEE) 802.11.

When device 302 is physically connected to network 304, device 302 is initially not allowed to access network 304. To access network 304, device 302 sends a request to trusted network connect 306 requesting access to network 304. Trusted network connect 306 is a software process running on server 308. Trusted network connect 306 provides authentication, authorization and accounting (AAA) services. For example, trusted network connect 306 may be a remote authentication dial in user service (RADIUS). Trusted network connect 306 sends a request to policy enforcement 310, requesting policy enforcement 310 to determine whether trusted network connect 306 should allow device 302 to connect to network 304.

Policy enforcement 310 is a software process on policy enforcement point 312. Policy enforcement 310 enforces user-defined policies for securing network 304. For example, policy enforcement 310 may enforce a policy requiring that a virus scan be performed on all disks connected to network 304. Policy enforcement point 312 may, for example, be a router which routes data packets in a wired or wireless network.

After receiving the request from device 302 to access network 304, policy enforcement 310 forwards the request to request to trusted network connect 306. Trusted network connect 306 is a software process running on server 308. Trusted network connect 306 provides authentication, authorization and accounting (AAA) services. For example, trusted network connect 306 may be a remote authentication dial in user service (RADIUS).

Trusted network connect 306 then attempts to obtain integrity verification directly from device 302. If integrity verification can be obtained directly from device 302, then device 302 is allowed access to network 304. If integrity verification cannot be obtained directly from device 302, trusted network connect 306 assumes that device 302 is a “dumb” device. Trusted network connect 306 then contacts external integrity verifier 314, asking external integrity verifier 314 to verify the integrity of device 302. External integrity verifier 314 determines whether device 302 is allowed access to network 304.

Generally, each policy in a trusted network content (TNC) architecture is based on the type of device requesting access to network 304. Therefore, external integrity verifier 314 first determines a type of device 302. To determine the type of device 302, external integrity verifier 314 may request device 302 to identify the type of device 302. If external integrity verifier 314 receives a response from device 302 identifying the type of device 302, then external integrity verifier 314 uses the type of device 302 to identify the policy to use with device 302. If external integrity verifier 314 does not receive a response from device 302 identifying the type of device 302, then external integrity verifier 314 may determine the type of device 302 using a different method. For example, external integrity verifier 314 may determine the type of device 302 using a media access control (MAC) address of device 302. A media access control (MAC) address is a unique identifier a manufacturer may place in a device, such as device 302. External integrity verifier 314 may use the media access control (MAC) address of device 302 to identify the type of device 302.

Upon determining the type of device, external integrity verifier 314 requests a policy for device 302 from trusted network connect 306. If external integrity verifier 314 identifies the type of device 302, external integrity verifier 314 requests a policy for device 302 based on the type of device 302. If external integrity verifier 314 is unable to determine the type of device 302, then external integrity verifier 314 may request a default policy.

Trusted network connect 306 accesses policy table 316 to select a policy for external integrity verifier 314 to use for device 302. Policy table 316 contains a set of entries. A set is one or more entries. Each entry in policy table 316 contains at least two entries, device type 318, and policy 320. Trusted network connect 306 accesses policy table 316 using the type of device 302 provided by external integrity verifier 314 and determines if the type of device 302 matches device type 318 in policy table 316. If the type of device 302 matches device type 318 in policy table 316, then trusted network connect 306 selects policy 320. If the type of device 302 is not in policy table 316, then trusted network connect 306 may select a default policy. In response to the request from external integrity verifier 314 requesting a policy for device 302, trusted network connect 306 sends the selected policy back to external integrity verifier 314.

External integrity verifier 314 receives the selected policy for device 302 from trusted network connect 306 and uses the selected policy to perform verification on device 302. For example, if device 302 is a disk and the selected policy specifies that a virus scan must be performed prior to allowing a disk to connect to network 304, then external integrity verifier 314 may perform a virus scan of device 302. If external integrity verifier 314 determines that device 302 meets the requirements of the selected policy, then external integrity verifier 314 sends a message to trusted network connect 306 indicating device 302 may be allowed to connect to network 304. If external integrity verifier 314 determines that device 302 does not meet the requirements of the selected policy, then external integrity verifier 314 sends a message to trusted network connect 306 indicating device 302 should not be allowed to connect to network 304.

If external integrity verifier 314 determines that device 302 does not meet the requirements of the selected policy, external integrity verifier 314 may instruct the Policy Enforcement point 310 to allow device 302 onto virtual local area network 322 in order to perform one or more remedial actions. A remedial action is an action for remedying the device to allow the device to be connected to the network.

For example, if external integrity verifier 314 determines that device 302 has a virus, external integrity verifier 314 will contact the Policy Enforcement point 310 which may connect device 302 to remediation virtual local area network 322, and quarantine the virus. Virtual local area network 322 may be a virtual network used to isolate devices which are not trusted. Virtual local area network 322 uses the physical architecture as network 304. However, virtual local area network 322 tags and routes the traffic of device 302 such that device 302 can only communicate with devices performing the remedial actions. A device is not trusted when external integrity verifier 314 determines that the device does not meet the requirements of a policy.

Another example of a remedial action is upgrading a firmware of device 302. For example, if the firmware of device 302 has a security flaw, and a firmware update addressing the security flaw is available, external integrity verifier 314 may connect device 302 to virtual local area network 322, and use virtual local area network 322 to update the firmware of device 302.

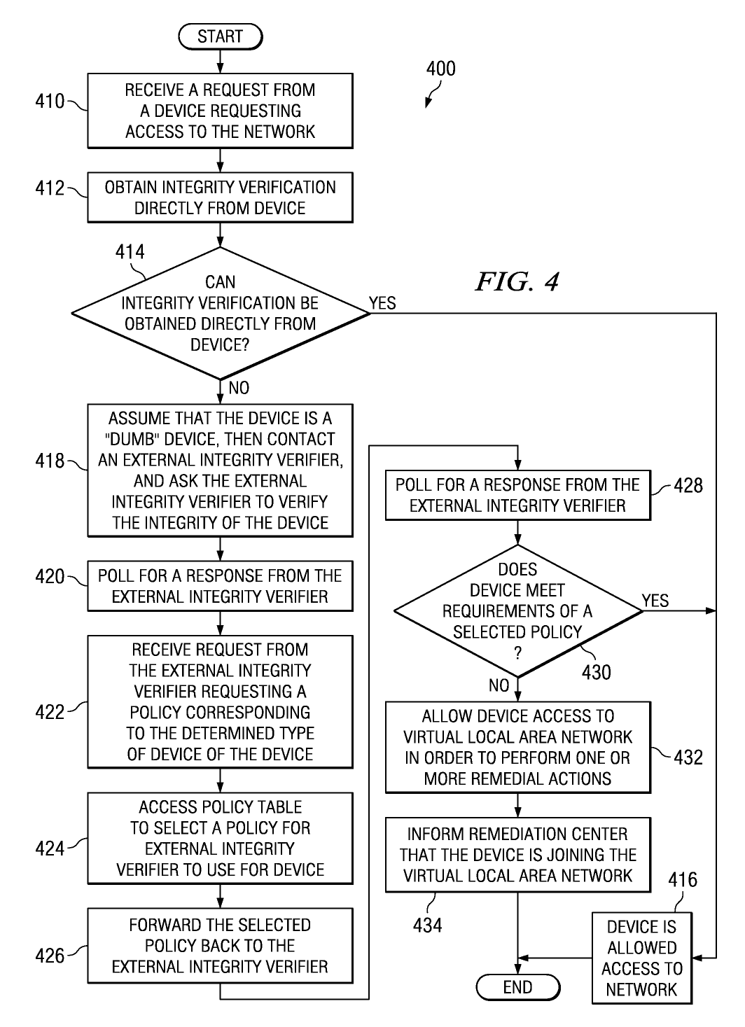

Referring now to FIG. 4, a flowchart for a software process providing authentication, authorization and accounting (AAA) services is shown in accordance with illustrative embodiments. Software process 400 of FIG. 4 can be trusted network connect 306 of FIG. 3.

Process 400 begins by receiving a request from a device requesting access to the network (step 410). Responsive to the receiving the request, process 400 attempts to obtain integrity verification directly from device (step 412). A determination is made as to whether the integrity verification can be obtained directly from the device (step 414). If integrity verification can be obtained directly from device (“yes” at step 414), then device is allowed access to network (step 416) with the process terminating thereafter.

If integrity verification cannot be obtained directly from device (“no” at step 414), process 400 assumes that the device is a “dumb” device. Process 400 then contacts an external integrity verifier, and asks the external integrity verifier to verify the integrity of the device (step 418). Process 400 then polls for a response from the external integrity verifier (step 420).

In response to asking the external integrity verifier to verify the integrity of the device, process 400 receives a request from the external integrity verifier requesting a policy corresponding to the determined type of device of the device (step 422).

Process 400 accesses a policy table and selects a policy for external integrity verifier to use for the device (step 424). The policy table contains a set of entries. Each entry in the policy table contains at least two entries, a device type and a policy corresponding thereto. Process 400 utilizes the type of device provided by the external integrity verifier to determine if the type of device matches a device type in the policy table. If the type of device matches a device type in policy table, then process 400 selects the associated policy. If the type of device is not located within the policy table, process 400 may instead select a default policy. Process 400 then forwards the selected policy back to the external integrity verifier (step 426).

Process 400 then polls for a response from the external integrity verifier (step 428). The response from the external integrity verifier indicates whether the device conforms to a selected integrity policy. If the external integrity verifier determines that device meets the requirements of a selected policy (“yes” at step 430), then the response from the external integrity verifier indicates that the device may be allowed to connect to the network. The device is allowed access to network (step 416) with the process terminating thereafter.

If the external integrity verifier determines that device does not meet the requirements of a selected policy (“no” at step 430), then the response from the external integrity verifier indicates that the device should not be allowed to connect to the network.

Process 400 then instructs the policy enforcement point to allow the device on the virtual local area network in order to perform one or more remedial actions (step 432). Process 400 can additionally inform a remediation center that the device joining the remediation network (step 434), with the process terminating thereafter. Therefore, the remediation center can proactively remediate the security policy concern with the device. For example, the remediation center will run a virus scan on the disk data.

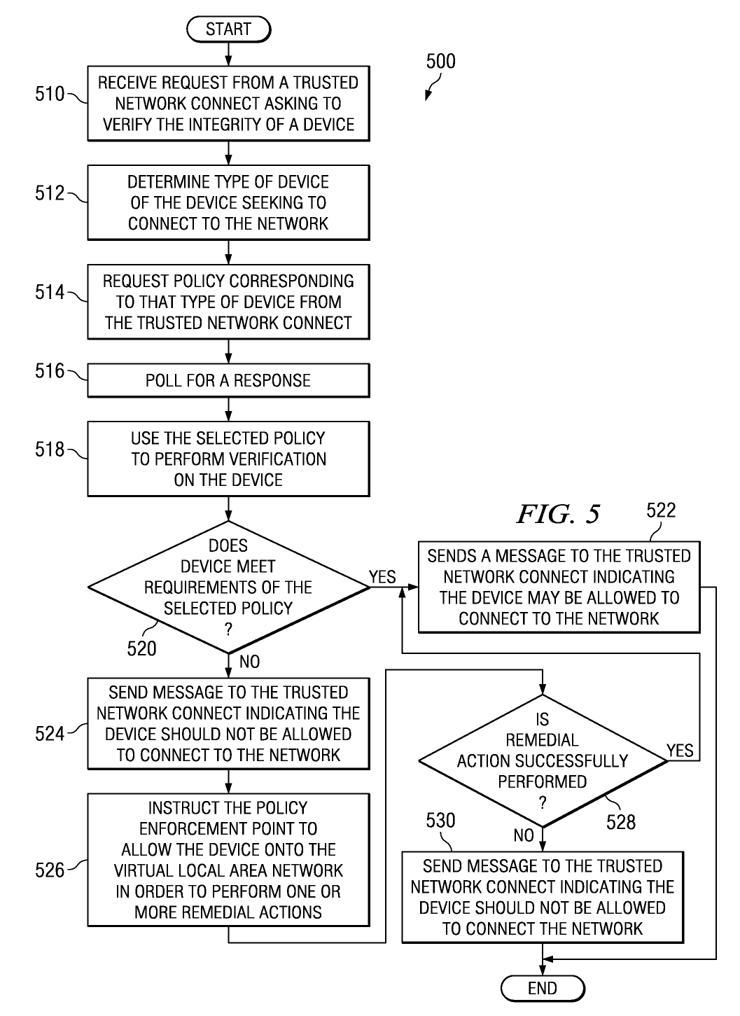

Referring now to FIG. 5, a flowchart for a software processes providing external integrity verification of a device is shown in accordance with illustrative embodiments. Process 500 determines whether a device is allowed access to a network. Process 500 is a software process, such as External integrity verifier 314 on policy enforcement point 312 as shown in FIG. 3.

Process 500 begins by receiving a request from a trusted network connect asking process 500 to verify the integrity of a device (step 510). Process 500 determines a type of device of the device seeking to connect to the network (step 512). To determine the type of device, process 500 may send a request to the device, requesting the device to identify the type of device. If process 500 receives a response from the device identifying the type of device, then external integrity verifier uses the type of device to identify the policy to use with the device. If process 500 does not receive a response from the device identifying the type of device, then process 500 may determine the type of device using a different method. For example, process 500 may determine the type of device using a media access control (MAC) address of the device. A media access control (MAC) address is a unique identifier a manufacturer may place in a device, such as device 302 of FIG. 3. Process 500 may use the media access control (MAC) address of the device to identify the type of device.

Upon determining the type of device, process 500 requests a policy corresponding to that type of device from the trusted network connect (step 514) and polls for a response (step 516).

Upon receipt of the selected policy for the device from the trusted network connect, process 500 uses the selected policy to perform verification on the device (step 518). For example, if the device is a disk and the selected policy specifies that a virus scan must be performed prior to allowing a disk to connect to the network, then process 500 may perform, or cause to be performed, a virus scan of the device. If process 500 then determines if the device meets the requirements of the selected policy (step 520). If the requirements are met (“yes” at step 520), then process 500 sends a message to the trusted network connect indicating the device may be allowed to connect to the network (step 522), with the process terminating thereafter.

If process 500 determines that the device does not meet the requirements of the selected policy (“no” at step 520), process 500 sends a message to the trusted network connect indicating the device should not be allowed to connect the network (step 524). Process 500 then instructs the policy enforcement point to allow the device onto the virtual local area network in order to perform one or more remedial actions (step 526), with the process terminating thereafter. The virtual local area network uses the physical architecture as the network. However, the virtual local area network tags and routes the traffic of device such that the device can only communicate with those networked devices performing the remedial actions. A remedial action is an action for remedying the device to allow the device to be connected to the network. For example, if external integrity verifier determines that device has a virus, external integrity verifier may connect device to a separate virtual network, and quarantine the virus. Separate virtual network may be a virtual network used to isolate devices which are not trusted. A device is not trusted when process 500 determines that the device does not meet the requirements of a policy.

Another example of a remedial action is upgrading a firmware of the device. For example, if the firmware of the device has a security flaw, and a firmware update addressing the security flaw is available, process 500 may the separate virtual network to update the firmware of the device.

If no remedial actions are performed (“no” at step 528), process 500 sends a message to the trusted network connect indicating the device should not be allowed to connect the network (step 530). Process 500 terminates thereafter.

If a remedial action is successfully performed, such that the device is in compliance with the selected policy (“yes” at step 528), then process 500 sends a message to the trusted network connect indicating the device may be allowed to connect to the network (step 522), with the process terminating thereafter.

The illustrated embodiments described herein provide a computer implemented method, a computer program product, and a data processing system for allowing a device access to a network in a trusted network connect environment. Responsive to receiving a request from the device to access the network, a type of the device is determined. Responsive to determining the type of the device, a policy for the device is determined based on the type of the device. Responsive to determining the policy for the device based on the type of the device, determining whether an integrity of the device satisfies the policy. Responsive to determining that the integrity of the device does not satisfy the policy, performing a remediation action on the device. Responsive to determining that the integrity of the device satisfies the policy, allowing the device access to the network.

The flowchart and block diagrams in the figures illustrate the architecture, functionality, and operation of some possible implementations of systems, methods and computer program products according to various embodiments. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method of allowing a device access to a network in a trusted network connect environment, the computer implemented method comprising:
responsive to receiving a request from the device to access the network, determining a type of the device;
responsive to determining the type of the device, determining a policy for the device based on the type of the device;
responsive to determining the policy for the device based on the type of the device, determining whether the device satisfies the policy; and
responsive to determining that the device satisfies the policy, allowing the device access to the network.

2. The computer implemented method of claim 1, further comprising:
responsive to determining that the device does not satisfy the policy, performing a remediation action on the device; and
responsive to performing the remediation action on the device, determining that the device satisfies the policy.

3. The computer implemented method of claim 1, wherein the step of receiving the request further comprises:
receiving the request in one of a remote authentication dial-in user service, or an authentication, authorization and accounting service.

4. The computer implemented method of claim 1, wherein the device is one of a network attached disk, and a network attached robot.

5. The computer implemented method of claim 1, wherein the step of determining a policy for the device based on the type of the device further comprises:
sending a request for a policy for the type of device to a trusted network connect server; and
receiving a response containing the policy for the type of device from the trusted network connect server.

6. The computer implemented method of claim 1, wherein the step of determining whether the device satisfies the policy further comprises performing at least one of running a virus scan of the device, checking for a recall notice of the device, and turning on a feature of the device.

7. The computer implemented method of claim 2, wherein the step of performing the remediation action on the device further comprises:
connecting the device to a second network, wherein the second network comprises a set of devices, and wherein each device in the set of devices is not a trusted device; and
performing the remediation action on the device while the device is connected to the second network.

8. The computer implemented method of claim 7, wherein the remediation action further comprises:
performing at least one of quarantining a virus, and updating a firmware of the device; and
responsive to determining the device satisfies the policy, allowing the device access to the network.

9. The computer implemented method of claim 1, wherein the step of allowing the device access to the network further comprises:
sending a message requesting a trusted network connect server to allow the device access to the network.

10. The computer implemented method of claim 1, wherein the step of determining a type of the device further comprises at least one of sending a request to the device to determine the type of the device, and retrieving a media access control address to determine the type of the device.

11. A computer program product comprising:
a computer readable medium having computer usable program code for allowing a device access to a network in a trusted network connect environment, the computer program product comprising:
computer usable program code, responsive to receiving a request from the device to access the network, for determining a type of the device;
computer usable program code, responsive to determining the type of the device, for determining a policy for the device based on the type of the device;
computer usable program code, responsive to determining the policy for the device based on the type of the device, for determining whether the device satisfies the policy; and
computer usable program code, responsive to determining that the device satisfies the policy, for allowing the device access to the network.

12. The computer program product of claim 11, further comprising:
computer usable program code, responsive to determining that the device does not satisfy the policy, for performing a remediation action on the device; and
computer usable program code, responsive to performing the remediation action on the device, for determining that the device satisfies the policy.

13. The computer program product of claim 11, wherein the computer usable program code for determining a type of the device further comprises:
receiving the request in one of a remote authentication dial-in user service, and an authentication, authorization and accounting service.

14. The computer program product of claim 11, wherein the device is one of a network attached disk, and a network attached robot.

15. The computer program product of claim 11, wherein the computer usable program code for determining a policy for the device based on the type of the device further comprises:
computer usable program code for sending a request for a policy for the type of device to a trusted network connect server; and
computer usable program code for receiving a response containing the policy for the type of device from the trusted network connect server.

16. The computer program product of claim 11, wherein the computer usable program code for determining whether the device satisfies the policy further comprises computer usable program code for performing at least one of running a virus scan of the device, computer usable program code for checking for a recall notice of the device, and computer usable program code for turning on a feature of the device.

17. The computer program product of claim 12, wherein the computer usable program code for performing a remediation action on the device further comprises:
computer usable program code for connecting the device to a second network, wherein the second network comprises a set of devices, and wherein each device in the set of devices is not a trusted device; and
computer usable program code for performing the remediation action on the device while the device is connected to the second network.

18. The computer program product of claim 17, wherein the remediation action further comprises:
computer usable program code for performing at least one of quarantining a virus, and updating a firmware of the device; and
computer usable program code responsive to determining the device satisfies the policy, for allowing the device access to the network.

19. The computer program product of claim 11, wherein the computer usable program code for allowing the device access to the network further comprises:
computer usable program code for sending a message requesting a trusted network connect server to allow the device access to the network.

20. A data processing system comprising:
A data processing system comprising:
a bus;
a communications unit connected to the bus;
a storage device connected to the bus, wherein the storage device includes computer usable program code for allowing a device access to a network in a trusted network connect environment; and
a processor unit connected to the bus, wherein the processor unit executes the computer usable program code, responsive to receiving a request from a device seeking access to a network, to determine a type of the device, responsive to determining the type of the device, to determine a policy for the device based on the type of the device, responsive to determining the policy for the device based on the type of the device, to determine whether the device satisfies the policy, responsive to determining that device satisfies the policy, responsive to determining that the device does not satisfy the policy, to perform a remediation action on the device, responsive to performing the remediation action on the device, to determine that the device satisfies the policy, and responsive to determining that the device satisfies the policy, to allow the device access to the network.
